(19) United States
(12) Patent Application Publication
(10) Pub. No.: US 2026/0152163 A1
(43) Pub. Date: Jun. 4, 2026

(54) BRAKE APPARATUS FOR VEHICLES

(71) Applicant: HYUNDAI MOTOR COMPANY, Seoul (KR)

(72) Inventor: Si Yoon PARK, Gyeonggi-do (KR)

(73) Assignee: HYUNDAI MOTOR COMPANY, Seoul (KR)

(21) Appl. No.: 19/307,696

(22) Filed: Aug. 22, 2025

(30) Foreign Application Priority Data
Dec. 3, 2024 (KR) 10-2024-0177558

(51) Int. Cl. B60T 13/74; F15B 15/14

(52) U.S. Cl. CPC B60T 13/745

(57) ABSTRACT

A brake apparatus for vehicles includes: a cylinder including a first port through which working fluid moves; a motor configured to generate rotational power; a screw shaft located in the cylinder, and configured to receive the rotational power from the motor; a nut coupled to the screw shaft, and configured to reciprocate in an axial direction in response to rotation of the screw shaft; a shaft bearing located in the cylinder, and coupled to the screw shaft; a sleeve located between the cylinder and the screw shaft, and including a closed first end facing the shaft bearing, and an open second end, the sleeve being brought into contact with and supported by the cylinder between the first port and the second end; and a piston coupled to the nut, and configured to reciprocate in the sleeve in response to reciprocating movement of the nut.

### CROSS-REFERENCE TO RELATED APPLICATION

This application claims priority from and the benefit of Korean Patent Application No. 10-2024-0177558, filed on Dec. 3, 2024, which is hereby incorporated by reference for all purposes as if set forth herein.

### BACKGROUND

### Field

Exemplary embodiments of the present disclosure relate to brake apparatus for vehicles, and more particularly, to a brake apparatus for vehicles in which a rotational motion of a screw shaft generated by rotational force of a motor may be converted into a linear motion of a piston.

### Discussion of the Background

In general, due to the characteristics of electrically-powered brake apparatuses for vehicles, a mechanism configured to convert a rotational motion of a motor into a linear motion of a piston in a cylinder to generate hydraulic brake pressure is required.

A ball screw device is applied to an electric brake apparatus as the mechanism for converting the rotational motion of the motor into the linear motion. The ball screw device includes a screw shaft that receives rotational force from the motor and rotates on an axis, a nut coupled to the screw shaft via balls and configured to move in an axial direction of the screw shaft, and a piston coupled to the nut and configured to pressurize a working fluid in the cylinder.

In related arts, when the piston moves forward and backward to form hydraulic pressure, if a central axis is excessively tilted, a gap may occur in a sealing structure that forms the hydraulic pressure, thus causing a leakage problem.

The background art of the present disclosure is disclosed in Korean Patent Laid-open Publication No. 10-2021-0064367 (published on Jun. 2, 2021, entitled “Hydraulic Unit for Hydraulic Vehicle Brake System”).

### SUMMARY

Various embodiments are directed to providing a brake apparatus for vehicles in which leakage between a sleeve and a cylinder may be prevented by suppressing wobbling of the sleeve.

A brake apparatus for vehicles according to an embodiment of the present disclosure may include: a cylinder including a first port through which working fluid moves; a motor configured to generate rotational power; a screw shaft located in the cylinder, and configured to receive the rotational power from the motor and to axially rotate; a nut coupled to the screw shaft, and configured to reciprocate in an axial direction of the screw shaft in response to rotation of the screw shaft; a shaft bearing located in the cylinder, and coupled to the screw shaft; a sleeve located between the cylinder and the screw shaft, and including a first end that is closed and faces the shaft bearing, and a second end that is open and opposite to the first end, the sleeve being brought into contact with and supported by the cylinder between the first port and the second end; and a piston coupled to the nut, and configured to reciprocate in the sleeve in response to reciprocating movement of the nut.

The cylinder may further include a second port spaced from the first port toward the first end of the sleeve. The sleeve may be brought into contact with and supported by the cylinder between the first port and the second port.

The cylinder may include a contact protrusion that is in surface contact with an outer surface of the sleeve between the first port and a region facing the second end.

The contact protrusion may be formed along a circumference of an inner surface of the cylinder.

A guide groove may be formed in the contact protrusion, the guide groove guiding the working fluid in the sleeve to the first port.

The guide groove may include a plurality of guide grooves arranged in the contact protrusion at set intervals.

The plurality of guide grooves formed in the contact protrusion may be oriented obliquely with respect to a central axis of the cylinder.

### BRIEF DESCRIPTION OF THE DRAWINGS

FIG. 1 is a sectional view illustrating a brake apparatus for vehicles according to an embodiment of the present disclosure.

FIG. 2 is a perspective view illustrating a cylinder unit viewed from one direction according to an embodiment of the present disclosure.

FIG. 3 is a perspective view illustrating the cylinder unit of FIG. 2 viewed from another direction.

FIG. 4 is a sectional view schematically illustrating the brake apparatus for vehicles according to an embodiment of the present disclosure.

FIG. 5 is a perspective view schematically illustrating an interior of the cylinder according to an embodiment of the present disclosure.

FIG. 6 is a view illustrating an operating state in which a piston moves forward inside the cylinder in the brake apparatus for vehicles according to an embodiment of the present disclosure.

FIG. 7 is a view illustrating an operating state in which the piston moves backward inside the cylinder in the brake apparatus for vehicles according to an embodiment of the present disclosure.

### DETAILED DESCRIPTION

Hereinafter, embodiments of a brake apparatus for vehicles according to the present disclosure will be described with reference to the accompanying drawings. It should be noted that the drawings are not to precise scale and may be exaggerated in thickness of lines or sizes of components for descriptive convenience and clarity only. Furthermore, the terms as used herein are defined by taking functions of the present disclosure into account and can be changed according to the custom or intention of users or operators. Therefore, definition of the terms should be made according to the overall disclosures set forth herein.

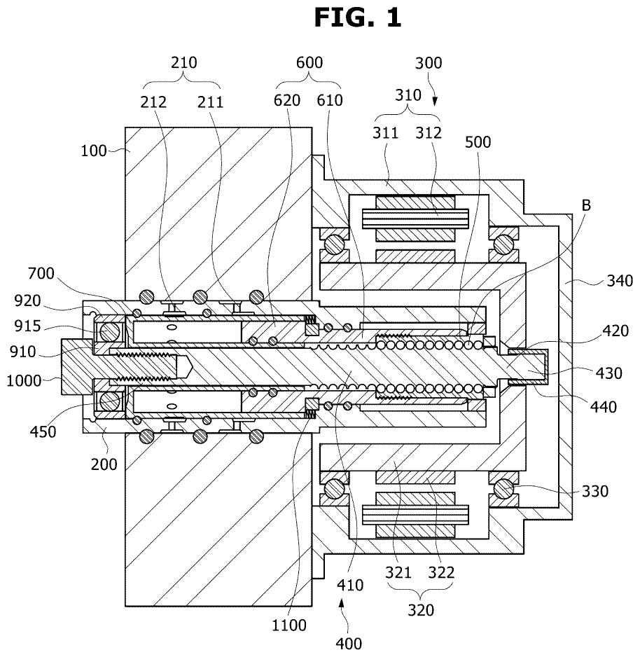

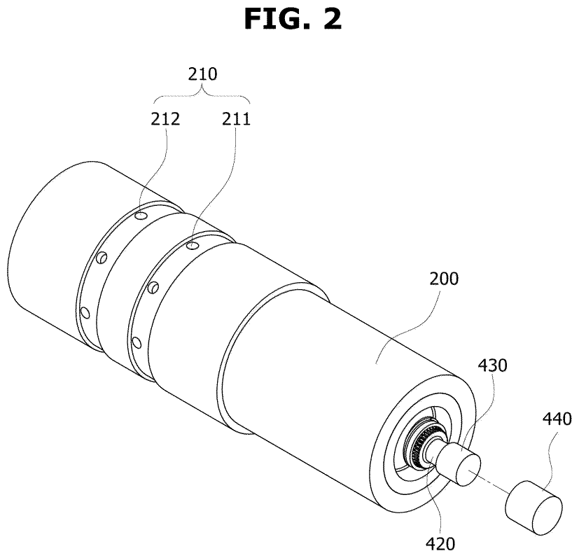

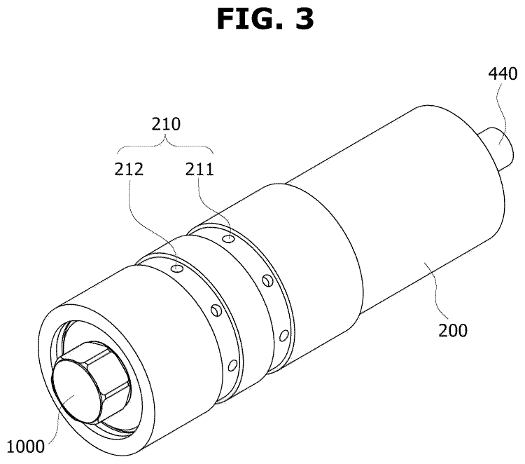

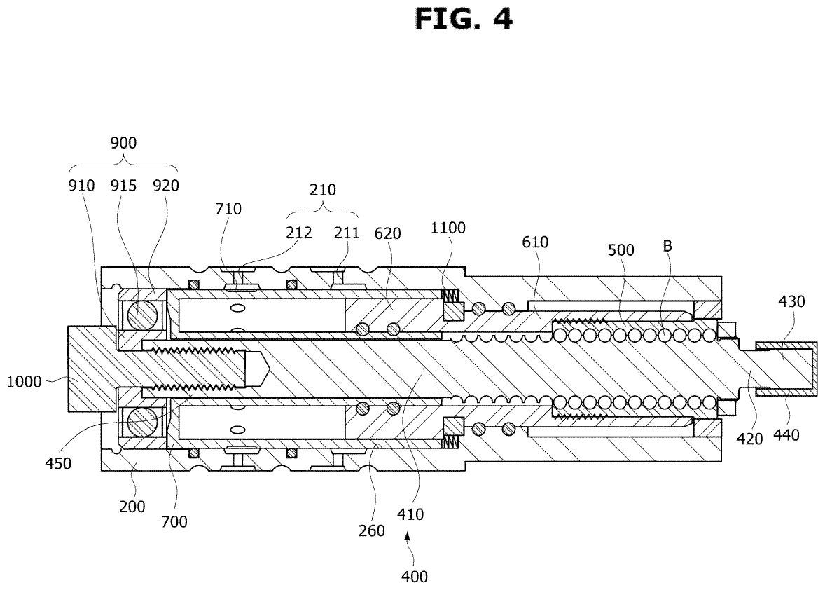

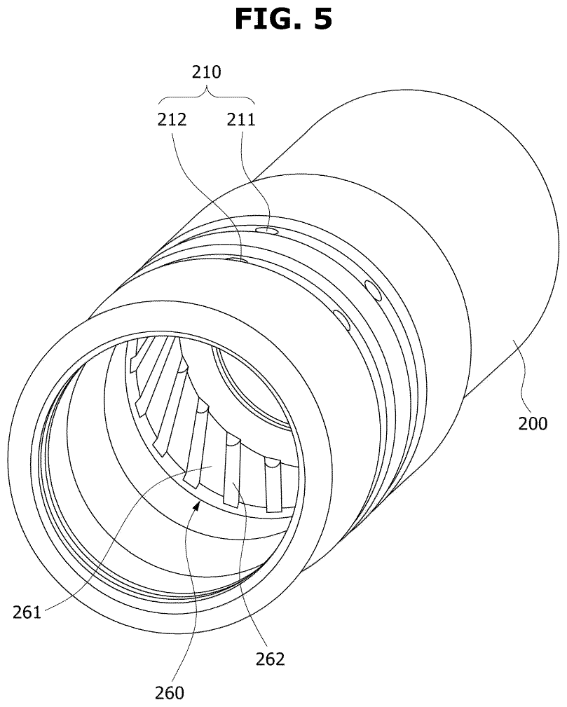

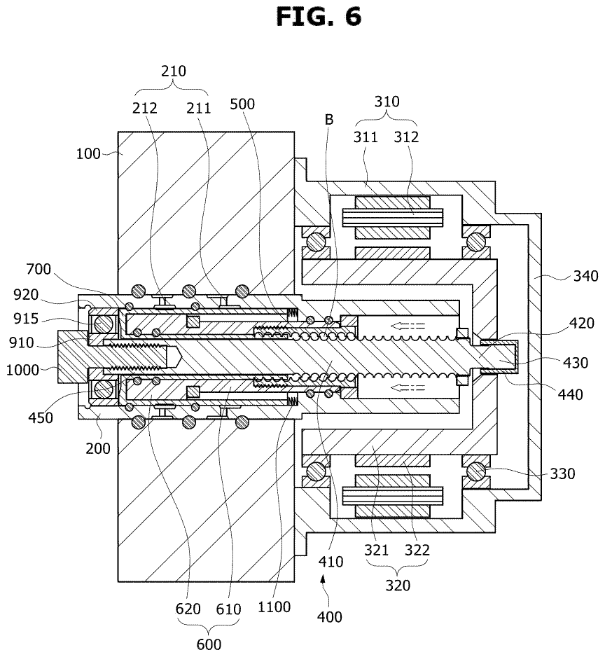

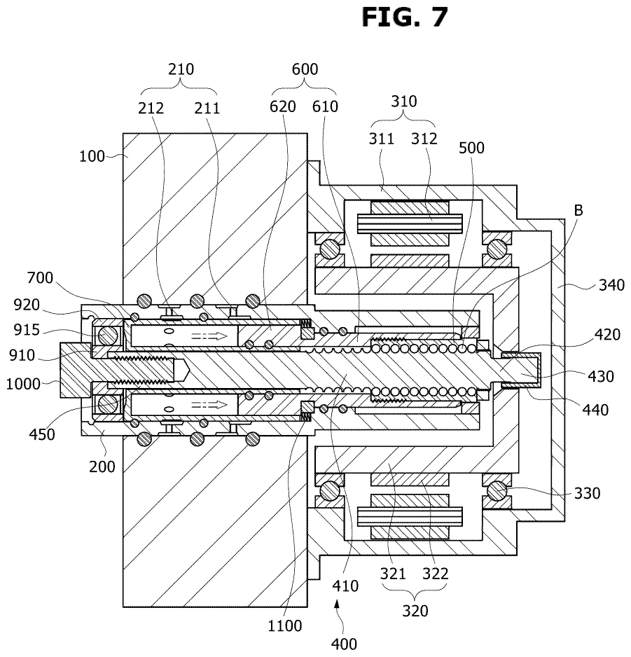

FIG. 1 is a sectional view illustrating a brake apparatus for vehicles according to an embodiment of the present disclosure. FIG. 2 is a perspective view illustrating a cylinder unit viewed from one direction according to an embodiment of the present disclosure. FIG. 3 is a perspective view illustrating the cylinder unit of FIG. 2 viewed from another direction. FIG. 4 is a sectional view schematically illustrating the brake apparatus for vehicles according to an embodiment of the present disclosure. FIG. 5 is a perspective view schematically illustrating an interior of the cylinder according to an embodiment of the present disclosure. FIG. 6 is a view illustrating an operating state in which a piston moves forward inside the cylinder in the brake apparatus for vehicles according to an embodiment of the present disclosure. FIG. 7 is a view illustrating an operating state in which the piston moves backward inside the cylinder in the brake apparatus for vehicles according to an embodiment of the present disclosure.

Referring to FIGS. 1 to 5, a brake apparatus for vehicles according to an embodiment of the present disclosure may include a cylinder 200, a motor 300, a screw shaft 400, a nut 500, a piston 600, and a sleeve 700.

The cylinder 200 may be located inside a housing 100 and may withstand torque generated by formation of hydraulic pressure according to reciprocating movement of the piston 600. The housing 100 according to an embodiment of the present disclosure may have a hollow shape in which an internal space is provided, and the cylinder 200 may be press-fitted into the housing 100.

The housing 100 may be provided on an outer side of the cylinder 200 (at a left side based on FIG. 1). The cylinder 200 may be assembled to the housing 100 under controlled concentricity.

The cylinder 200 may have a hollow shape. A sleeve 700, in which an operation section is provided to allow hydraulic pressure to be formed by pressing of the piston 600, may be located in one side space (at the left side based on FIG. 1) inside the cylinder 200.

The motor 300 may be connected to the cylinder 200, and various types of drive devices may be used within a technical idea in which rotational power can be generated. The motor 300 may transmit rotational power (torque) to the screw shaft 400.

The motor 300 may include a stationary component 310, a rotational component 320, and a motor bearing 330.

The stationary component 310 may be fixed to the housing 100, and may be formed in various shapes within a technical idea in which magnetic force is changed by supply of power.

The stationary component 310 may include a fixing frame 311 fixed to one side of the housing 100 (at a right side based on FIG. 1), and a stator 312 that is installed on an inner surface of the fixing frame 311 facing the rotational component 320 and is configured to generate magnetic force.

The fixing frame 311 may be connected to one side of the housing 100. The rotational component 320 may be rotatably installed inside the fixing frame 311.

The stator 312, which is an electromagnet, may be installed in a circumferential direction on an inner surface of the fixing frame 311, and may rotate the rotational component 320 by changing magnetic flux in response to a control signal from a controller (not shown).

The rotational component 320 may be connected to the screw shaft 400, and may rotate together with the screw shaft 400. The rotational component 320 may be modified into various shapes within a technical idea in which the rotational component 320 can rotate according to a change in magnetic force of the stationary component 310.

The rotational component 320 may be rotatably installed inside the fixing frame 311. The rotational component 320 may have an approximately “C”-shaped cross-section, and may be formed in a hollow shape.

The rotational component 320 may include a rotational frame 321 installed in a shape enclosing one side (the right side based on FIG. 1) of the cylinder 200, and a rotor 322 that is provided on an outer surface of the rotational frame 321 facing the stationary component 310 and has magnetic force.

A spline that engages with the screw shaft 400 may be formed in the rotational frame 321, specifically on an inner surface of the rotational frame 321.

The motor bearing 330 may be provided between the stationary component 310 and the rotational component 320 to reduce friction generated during rotation of the rotational component 320. The rotor 322, which is formed of a plurality of magnets installed in a circumferential direction of the rotational frame 321, may rotate along with the rotational frame 321 by a change in magnetic force of the stator 312.

A frame cover 340 secured to the fixing frame 311 may be installed in a shape enclosing an outer surface of an end of the rotational frame 321 to block the entry of foreign substances.

The screw shaft 400 may be provided inside the cylinder 200. The screw shaft 400 may be inserted in a longitudinal direction of the cylinder 200 (a left-right direction based on FIG. 1), and may be axially coupled to the cylinder 200. A central axis of the cylinder 200 and a central axis of the screw shaft 400 may coincide with each other.

The screw shaft 400 may be secured to a shaft bearing 900 by a support component 1000. The support component 1000 may rotatably support the screw shaft 400.

The screw shaft 400 may include a screw body 410, a neck portion 420, a power transmission portion 430, and a coupling portion 450.

The screw body 410 may be rotatably installed inside the cylinder 200, and may include a helical thread formed along a longitudinal direction of the screw shaft 400. The screw body 410 may be located inside the rotational frame 321 of the motor 300.

The neck portion 420 may protrude from an outer surface around a rotating center of the screw body 410 toward a first side (a right side based on FIG. 1), and may be formed to have a diameter smaller than that of the screw body 410.

The power transmission portion 430 may extend from a free end of the neck portion 420 toward the first side (the right side based on FIG. 1), and may be formed to have a diameter larger than that of the neck portion 420.

A spline may be formed along a circumferential direction on an outer surface of the power transmission portion 430 facing the rotational frame 321. Accordingly, in the case where a shaft cover 440, which will be described later, is not provided, the rotational frame 321 and the power transmission portion 430 may engage with each other to transmit power.

The screw shaft 400 may further include the shaft cover 440. The shaft cover 440 may be disposed to enclose the neck portion 420 and the power transmission portion 430. The shaft cover 440 may be interposed between the power transmission portion 430 and the rotational frame 321 to prevent metallic rattle noise from being generated.

A spline may be formed on an outer surface of the shaft cover 440 along a circumferential direction of the shaft cover 440, and may engage with the rotational frame 321. An outer shape of the shaft cover 440 may correspond to an outer shape of the power transmission portion 430.

A spline may be formed along a circumferential direction on an outer surface of the power transmission portion 430 facing the shaft cover 440. Accordingly, the shaft cover 440 and the power transmission portion 430 may engage with each other to transmit power.

The coupling portion 450 may extend from the outer surface around the rotating center of the screw body 410 toward a second side (a left side based on FIG. 1), and may be rotatably coupled to the shaft bearing 900. The coupling portion 450 may be coupled to the shaft bearing 900 by press-fitting. The coupling portion 450 may be formed to have a diameter equal to or less than that of the screw body 410.

The nut 500 may be positioned inside the rotational frame 321 of the motor 300, and may be located inside the cylinder 200.

The nut 500 may be coupled to an outer surface of the screw shaft 400 via a ball B.

The screw shaft 400 may be coupled through the nut 500. Because the ball B is located between a helical thread formed on an inner surface of the nut 500 and the helical thread formed on an outer surface of the screw body 410, rotational motion of the screw shaft 400 may be converted into linear motion through the nut 500.

A rotation prevention protrusion (not shown) may be formed on an outer surface of the nut 500, and a movement groove (not shown) may be formed in an inner surface of the cylinder 200.

When the screw shaft 400 rotates, the nut 500 does not rotate because rotation of the rotation prevention protrusion of the nut 500 is blocked by the movement groove. Accordingly, the rotational motion of the screw shaft 400 may be converted into the linear motion of the nut 500 by the rotation prevention protrusion and the movement groove.

The nut 500 may reciprocate in an axial direction of the screw shaft 400 according to a rotational direction of the screw shaft 400. For example, if the nut 500 moves forward when the screw shaft 400 rotates in a first direction, the nut 500 may move backward when the screw shaft 400 rotates in a second direction opposite to the first direction.

The piston 600 may be coupled in a manner of enclosing an outer side of the nut 500. The piston 600 may move in the longitudinal direction of the cylinder 200 in conjunction with the reciprocating movement of the nut 500.

The piston 600 may include a rod 610 and a head 620.

The rod 610 may be formed in a hollow shape, and may be positioned inside the rotational frame 321 of the motor 300. The outer surface of the nut 500 and an inner surface of the rod 610 may be thread-coupled to each other.

The head 620 may be integrally formed with the rod 610. An outer diameter of the head 620 may be greater than an outer diameter of the rod 610.

The head 620 may be formed in a ring shape, may be positioned inside the housing 100, and may reciprocate inside the sleeve 700 to move working fluid inside the sleeve 700 toward ports 210. Accordingly, the cylinder 200 may form a double-acting hydraulic pressure according to reciprocating movement of the piston 600.

The sleeve 700 may be positioned inside the housing 100, and may be disposed inside the cylinder 200. The sleeve 700 may guide movement of the piston 600 inserted therein. The sleeve 700 may be formed to enclose the head 620 of the piston 600.

The sleeve 700 may be closed at a first end thereof (at a left side based on FIG. 1) facing the shaft bearing 900, and may be open at a second end thereof (at a right side based on FIG. 1) opposite to the first end. The piston 600 may be inserted into the sleeve 700 through the open second end of the sleeve 700. As the piston 600 moves inside the sleeve 700, hydraulic pressure may be formed between the piston 600 and the closed first end of the sleeve 700.

The ports 210 through which the working fluid flows may be provided on an outer surface of a region of the cylinder 200 where the sleeve 700 is located. The ports 210 may be respectively provided at a plurality of points along the longitudinal direction of the cylinder 200.

The port 210 may include a first port 211, and a second port 212 located to be spaced apart from the first port 211 toward the first end of the sleeve 700. The working fluid that moves according to the movement of the piston 600 may flow through the first port 211 and the second port 212 to form required braking pressure.

The sleeve 700 may be brought into contact with and supported on an inner surface of the cylinder 200 between the first port 211 and the second port 212. Accordingly, wobbling of the sleeve 700 may be suppressed during operation of the brake apparatus for vehicles, including during reciprocating movement of the piston 600, thereby preventing leakage between the sleeve 700 and the cylinder 200.

The cylinder 200 may include a contact protrusion 260 on an inner surface thereof. The contact protrusion 260 may be in surface contact with an outer surface of the sleeve 700 between the first port 211 and a region facing the open second end of the sleeve 700.

The contact protrusion 260 may be formed along a circumference of the inner surface of the cylinder 200. The contact protrusion 260 may include contact surfaces 261 that are in contact with an outer surface of the sleeve 700, and a guide groove 262 that separates adjacent contact surfaces 261 from each other.

The guide groove 262 may guide the working fluid inside the sleeve 700 to the first port 211. The guide groove 262 may extend continuously from one end of the contact protrusion 260 to a remaining end along a longitudinal direction of the contact protrusion 260.

According to the present disclosure, the contact protrusion 260 may include the one end oriented toward the first port 211 and the remaining end located opposite to the one end. The guide groove 262 may be formed in a recessed groove shape continuously extending from the one end to the remaining end of the contact protrusion 260. Accordingly, the working fluid inside the sleeve 700 may flow into the guide groove 262 from the remaining end side of the contact protrusion 260, may flow along the guide groove 262, and may be discharged from the guide groove 262 at the one end side of the contact protrusion 260. The discharged working fluid may be moved to the outside of the sleeve 700 through the first port 211.

A plurality of guide grooves 262 may be arranged in the contact protrusion 260 at predetermined intervals. Accordingly, the working fluid in the sleeve 700 may smoothly move toward the first port 211 along the plurality of guide grooves 262.

The guide grooves 262 may be oriented obliquely with respect to a central axis of the cylinder 200. The guide grooves 262 may extend in the longitudinal direction of the cylinder 200, and may be oriented obliquely with respect to the longitudinal direction of the cylinder 200. Accordingly, the sleeve 700 may be uniformly in contact with the contact surfaces 261 over the entire outer surface of the sleeve 700, and may be stably supported by the cylinder 200.

Because the sleeve 700 is supported in surface contact with the contact protrusion 260 of the cylinder 200 between the region facing the open second end of the sleeve 700 and a region where the first port 211 is formed, wobbling of the sleeve 700 may be suppressed during operation of the brake apparatus for vehicles, including during reciprocating movement of the piston 600, thereby preventing leakage between the sleeve 700 and the cylinder 200.

A cut-off hole 710 in communication with the port 210 may be formed in the outer surface of the sleeve 700.

A plurality of cut-off holes 710 may be arranged to be spaced apart from each other in a circumferential direction of the sleeve 700. Accordingly, the working fluid inside the sleeve 700 may be discharged in a radial direction of the piston 600.

The brake apparatus for vehicles according to an embodiment of the present disclosure may include a shaft bearing 900. The shaft bearing 900 may be located inside the housing 100, and may be provided at an end inside the cylinder 200.

An outer surface of the shaft bearing 900 and an outer surface of the sleeve 700 may be installed in contact with each other. The shaft bearing 900 may be coupled to the screw shaft 400 in a shape enclosing the coupling portion 450 of the screw shaft 400.

The shaft bearing 900 may include an inner ring 910, a bearing ball 915, and an outer ring 920. The inner ring 910 may be in contact with the coupling portion 450 of the screw shaft 400, and the outer ring 920 may be installed in contact with the inner surface of the cylinder 200.

The shaft bearing 900 may support an axial load during formation of hydraulic pressure inside the cylinder 200 by the piston 600 that reciprocates in the axial direction of the screw shaft 400.

The brake apparatus for vehicles according to an embodiment of the present disclosure may include the support component 1000. The support component 1000 may be provided inside the cylinder 200. The support component 1000 may be inserted into the coupling portion 450, and may be coupled to the screw shaft 400.

The support component 1000 may be thread-coupled to the screw shaft 400. The shaft bearing 900 may be fixed to the support component 1000. The support component 1000 may rotatably support the screw shaft 400. The support component 1000 may be a bolt.

The brake apparatus for vehicles according to an embodiment of the present disclosure may include a reaction force component 1100. A first side of the reaction force component 1100 may be supported by the cylinder 200, and a second side of the reaction force component 1100 may be brought into contact with the sleeve 700 to press the sleeve 700 toward the shaft bearing 900. The reaction force component 1100 may be a wave spring.

An operation process of the brake apparatus for vehicles according to an embodiment of the present disclosure having the aforementioned configuration will be described below.

Referring to FIG. 6, when the motor 300 operates to transmit rotational force to the screw shaft 400, the screw shaft 400 may rotate on its axis in a first rotational direction inside the cylinder 200, and the nut 500 may move forward along the screw shaft 400 toward the sleeve 700.

In response to the movement of the nut 500 toward the sleeve 700, the piston 600 coupled to the nut 500 may linearly move forward inside the cylinder 200 in the same direction as the movement direction of the nut 500, thus forming hydraulic brake pressure.

Referring to FIG. 7, when the motor 300 operates such that the screw shaft 400 rotates on its axis inside the cylinder 200 in a second rotational direction opposite to the first rotational direction, the nut 500 may move backward along the screw shaft 400 in a direction opposite to the sleeve 700.

In response to the movement of the nut 500 in the direction opposite to the sleeve 700, the piston 600 coupled to the nut 500 may linearly move backward inside the cylinder 200 in the same direction as the movement direction of the nut 500, thus forming hydraulic brake pressure. Accordingly, as the piston 600 linearly moves forward and backward inside the cylinder 200, a double-acting hydraulic pressure may be formed.

According to the present disclosure, wobbling of the sleeve may be suppressed, thereby preventing leakage between the sleeve and the cylinder.

According to the present disclosure, because a plurality of guide grooves are formed in an inner surface of the cylinder, working fluid inside the sleeve may smoothly move along the guide grooves.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A brake apparatus for vehicles, comprising:
a cylinder including a first port through which working fluid moves;
a motor configured to generate rotational power;
a screw shaft located in the cylinder, and configured to receive the rotational power from the motor and to axially rotate;
a nut coupled to the screw shaft, and configured to reciprocate in an axial direction of the screw shaft in response to rotation of the screw shaft;
a shaft bearing located in the cylinder, and coupled to the screw shaft;
a sleeve located between the cylinder and the screw shaft, and including a first end that is closed and faces the shaft bearing, and a second end that is open and opposite to the first end, the sleeve being brought into contact with and supported by the cylinder between the first port and the second end; and
a piston coupled to the nut, and configured to reciprocate in the sleeve in response to reciprocating movement of the nut.

2. The brake apparatus of claim 1,
wherein the cylinder further includes a second port spaced from the first port toward the first end of the sleeve, and
wherein the sleeve is brought into contact with and supported by the cylinder between the first port and the second port.

3. The brake apparatus of claim 1, wherein the cylinder includes a contact protrusion that is in surface contact with an outer surface of the sleeve between the first port and a region facing the second end.

4. The brake apparatus of claim 3, wherein the contact protrusion is formed along a circumference of an inner surface of the cylinder.

5. The brake apparatus of claim 4, wherein a guide groove is formed in the contact protrusion, the guide groove guiding the working fluid in the sleeve to the first port.

6. The brake apparatus of claim 5, wherein the guide groove comprises a plurality of guide grooves arranged in the contact protrusion at set intervals.

7. The brake apparatus of claim 6, wherein the plurality of guide grooves formed in the contact protrusion are oriented obliquely with respect to a central axis of the cylinder.
